(19) United States
(12) Patent Application Publication
(10) Pub. No.: US 2024/0023479 A1
(43) Pub. Date: Jan. 25, 2024

(54) AGRICULTURAL SLURRY APPLICATOR

(71) Applicant: Raven Industries, Inc., Sioux Falls, SD (US)

(72) Inventors: Jared Ernest Kocer, Sioux Falls, SD (US); Charlie R. Schoenfelder, Sioux Falls, SD (US); Nicholas O. Michael, Sioux Falls, SD (US); Thomas Lawrence Herbert, Rock Rapids, IA (US)

(21) Appl. No.: 18/339,156

(22) Filed: Jun. 21, 2023

Related U.S. Application Data
(60) Provisional application No. 63/354,112, filed on Jun. 21, 2022.
(60) Provisional application No. 63/367,910, filed on Jul. 7, 2022.

(51) Int. Cl. A01C 21/00; A01C 23/00

(52) U.S. Cl. CPC A01C 21/005; A01C 23/007; A01C 23/002; A01C 23/005; A01C 23/008

(57) ABSTRACT

In an example, an agricultural slurry is applied to a field, for instance to change a constituent profile of the soil. For instance, a slurry application system includes a slurry applicator configured to apply the agricultural slurry. In another example, characteristics of the agricultural slurry are determined with a sensor. The characteristics of the agricultural slurry are compared with corresponding application thresholds. In yet another example, a slurry application controller cooperates with the slurry applicator or a prime mover to apply the agricultural slurry based on the comparison.

### CLAIM OF PRIORITY

This patent application claims the benefit of priority of Hubert U.S. Provisional Patent Application Ser. No. 63/354,112, entitled “AGRICULTURAL SLURRY APPLICATOR,” filed on Jun. 21, 2022 (Attorney Docket No. 2754.474PRV); and of Kocer et al. U.S. Provisional Patent Application Ser. No. 63/367,910, entitled “AGRICULTURAL SLURRY APPLICATOR,” filed on Jul. 7, 2022 (Attorney Docket No. 2754.474PV2) the benefit of priority of each of which is claimed hereby, and each of which are incorporated by reference herein in its entirety.

### TECHNICAL FIELD

This document pertains generally, but not by way of limitation, to agriculture, or amending soil for agriculture.

### BACKGROUND

In an approach, an agricultural slurry is applied to soil (e.g., a farm field, arable land, or the like). The agricultural slurry may include manure, for instance manure produced by livestock proximate the field. The agricultural slurry is amended into the soil to augment constituents of the soil. For example, the agricultural slurry is amended into the soil to change one or more of nitrogen concentration, ammonia concentration, ammonium concentration, phosphorous concentration, or potassium concentration of the soil. Accordingly, the agricultural slurry is applied to the soil to achieve a target characteristic profile for the soil.

In another approach, the agricultural slurry is collected in a slurry reservoir. The agricultural slurry is conveyed from the slurry reservoir and applied to the soil at a specified rate to fertilize the soil. Health of the crops growing in the soil is monitored after application of the agricultural slurry to the soil (e.g., by the farmer). In another approach, the specified rate of applying the agricultural slurry is reduced (e.g., later in the season, next season, or the like) based on observed wilting of crops, defoliation of the crops, browning of leaves, or the like.

In yet another approach, the characteristic profile of the agricultural slurry is determined prior to application of the agricultural slurry to the soil, for instance with sampling of the collected slurry. The characteristic profile of the agricultural slurry is used by the operator to set the rate of application for the agricultural slurry (e.g., through manual setting of a flow valve). Accordingly, the agricultural slurry is applied at the specified rate to the soil.

### SUMMARY

The present inventors have recognized, among other things, that a problem to be solved may include achieving a target characteristic profile for soil using a slurry applicator. In an example, the soil has an initial characteristic profile (e.g., at the beginning of a farming season, in the spring, in the fall, or the like), for instance before crops are planted in the soil. The present subject matter provides a solution to this problem. For example, the slurry applicator applies an agricultural slurry to the soil to change the characteristic profile of the soil (from the initial characteristic profile). Accordingly, in some examples, the characteristic profile of the soil is changed to support crops planted in the soil (or crops that will be planted in the soil).

In another example, the present inventors have recognized, among other things, that a problem to be solved may include automated application of an agricultural slurry using a slurry applicator to achieve the target characteristic profile for the soil. The present subject matter provides a solution to this problem. For example, a slurry application system includes the slurry applicator, and the slurry applicator is coupled with a prime mover (e.g., tractor, truck, or the like). The prime mover transports the slurry applicator through the field to apply the agricultural slurry. In another example, the slurry applicator includes one or more knives (e.g., rippers, teeth, ploughs, coulters, or the like) that engage with the soil to loosen or turn the soil. The slurry applicator includes one or more nozzles to apply the agricultural slurry to the soil. For instance, the nozzles apply the agricultural slurry proximate the soil loosened with the knives. In yet another example, the agricultural slurry application system includes a slurry application controller that controls application of the agricultural slurry with one or more of the prime mover or the slurry applicator. Accordingly, the system uses the slurry application controller to automate application of the agricultural slurry. For example, the system applies a specified quantity (e.g., mass, weight, volume, flow rate, mass flow rate, volumetric flow rate, or the like) of agricultural slurry to the field according to a prescription map. Thus, the system uses the prescription map and the slurry applicator to apply agricultural slurry to the field in an automated manner.

In a further example, the initial characteristic profile for soil is determined for one or more zones of a field where it is desired to apply the agricultural slurry to the soil. The prescription map is developed using the determined initial characteristic profile of the soil and the target characteristic profile for the soil within the zones of the field. The prescription map includes one or more zones corresponding to subdivided sections of the field. Each zone of the prescription map has one or more application thresholds (associated with a target characteristic profile) for the agricultural slurry. For instance, the slurry applicator applies the agricultural slurry to achieve or satisfy the application thresholds for each zone of the prescription map. Thus, the slurry application system applies agricultural slurry to the soil in an automated manner according to the prescription map to change characteristics of the field (away from the initial characteristic profile and into achievement of the application thresholds).

In yet another example, the one or more application thresholds are specified characteristics for the field (or specified zones of the field) that correspond with characteristics of the agricultural slurry. The characteristics of the agricultural slurry include (but are not limited to) one or more of nitrogen concentration, ammonia concentration, ammonium concentration, phosphorous concentration, potassium concentration, or dry matter concentration of the agricultural slurry. Accordingly, the one or more application thresholds for the field include (but are not limited to) one or more specified values for nitrogen concentration, ammonia concentration, ammonium concentration, phosphorous concentration, potassium concentration, or dry matter concentration of the agricultural slurry or derived values based on specified concentrations. In one example, the application thresholds are set points, target values or the like provided by the system to control the application of a specified quantity (e.g., mass, weight, volume, flow rate, mass flow rate, volumetric flow rate, or the like) of the agricultural slurry to the field to achieve a target characteristic profile for the soil (e.g., corresponding to one or more of the application thresholds).

In still yet another example, the present inventors have recognized, among other things, a problem to be solved includes application of an agricultural slurry that is not homogenous (e.g., slurry having changing characteristics) during the application of the agricultural slurry. For instance, and in some examples, the characteristics of the agricultural slurry (e.g., the various concentrations of the slurry components) contained in the slurry reservoir change as the agricultural slurry is drawn from the reservoir and applied.

For instance, the dry matter concentration, nitrogen concentration or the like of the agricultural slurry varies based on depth of the slurry within the slurry reservoir. In some examples, the agricultural slurry contained in the slurry reservoir is not homogenous, and accordingly the composition of the agricultural slurry changes based on location within the slurry reservoir. For example, the dry matter concentration is greater at the surface of the slurry reservoir in comparison to the dry matter concentration at the bottom of the slurry reservoir. In some examples, solid matter floats atop liquid in the slurry reservoir. Accordingly, the dry matter concentration (e.g., a ratio of solid matter to liquid matter within the agricultural slurry) changes based on depth of the slurry within the reservoir. In other examples, nitrogen, ammonia, ammonium and phosphorous concentrations vary within the slurry, and may change as slurry is drawn from the reservoir. Accordingly, in some examples, drawing of the agricultural slurry changes the characteristics of the slurry because the slurry is not homogenous.

In another example, the dry matter concentration of the agricultural slurry changes in accordance with application of the agricultural slurry to soil. Application of the slurry to the soil removes liquid (and solids) from the surface of the agricultural slurry contained in the slurry reservoir. The removal of liquid (and solids) from the surface of the slurry reservoir changes the composition of the slurry contained in the reservoir. For example, the conduit draws agricultural slurry having a greater dry matter concentration from the surface of the slurry reservoir (in contrast to the dry matter concentration at the bottom of the slurry reservoir). Accordingly, the dry matter concentration for the agricultural slurry remaining in the slurry reservoir decreases in correspondence with application of the agricultural slurry to the soil.

The present subject matter provides a solution to this problem. For example, the agricultural slurry application system includes a slurry characteristic sensor that determines the characteristics of the agricultural slurry. The slurry characteristic sensor is coupled with one or more of the slurry reservoir or a conduit between the slurry reservoir and the slurry applicator. In an example, the slurry application controller communicates with the slurry characteristic sensor to control application of the agricultural slurry with the slurry applicator. The slurry application controller uses the determined slurry characteristics to control one or more of the prime mover or the slurry applicator. In an example, the slurry application controller changes speed of the prime mover based on the determined slurry characteristics (e.g., speeding up for high concentration slurry and slowing for low concentration slurry). In another example, the slurry application controller changes flow rate of agricultural slurry through the slurry applicator based on the determined slurry characteristics (e.g., decreasing flow rate for high concentration slurry and increasing flow rate for low concentration slurry). Accordingly, the system controls application of the agricultural slurry using the slurry characteristic sensor to operate one or more of the slurry applicator or the prime mover based on the determined slurry characteristics.

In yet another example, the present inventors have recognized, among other things, that a problem to be solved includes achieving a target characteristic profile for soil using an agricultural slurry that is not homogenous. The present subject matter provides a solution to this problem. For example, the agricultural slurry application system determines characteristics of the non-homogenous slurry, and the system controls one or more of the prime mover or the slurry applicator based on the determined characteristics of the slurry to achieve a target characteristic profile for the soil. For instance, the nitrogen concentration of the agricultural slurry applied to soil changes in accordance with drawing of the slurry from the slurry reservoir. The system uses the slurry characteristic sensor to determine the nitrogen concentration of the agricultural slurry, and the slurry application controller controls one or more of the slurry applicator or the prime mover to apply a specified quantity (e.g., mass, weight, volume, flow rate, mass flow rate, volumetric flow rate, or the like) of the agricultural to soil and achieve a target characteristic profile for the soil. For instance, the system controls one or more of the prime mover or the slurry applicator to achieve a specified nitrogen concentration for each zone within the prescription map. Thus, the slurry application system determines characteristics of an agricultural slurry and controls application of the agricultural slurry based on the determined characteristics of the agricultural slurry. As a result, the system achieves target characteristic profiles within each zone of the field using the non-homogenous agricultural slurry.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of an example of an agricultural slurry application system.

FIG. 2 is an aerial view of the agricultural slurry application system.

FIG. 3 is a schematic view of another example of the slurry application system.

FIG. 4 is an aerial view of an example of a field with a first layer of a prescription map overlaid upon the field.

FIG. 5 is an aerial view of another example of the field with a second layer of the prescription map of FIG. 4 overlaid upon the field.

FIG. 6 is an aerial view of yet another example of the field with a third layer of the prescription map of FIG. 4 overlaid upon the field.

FIG. 7 is an aerial view of another example of the field with a fourth layer of the prescription map of FIG. 4 overlaid upon the field.

FIG. 8 is a schematic diagram of an example of an algorithm for determining a slurry application value.

FIG. 9 is a schematic diagram of another example of an algorithm for determining a slurry application value.

FIG. 10 is one example of a method for applying an agricultural slurry.

FIG. 11 illustrates a block diagram of an example machine upon which any one or more of the techniques discussed herein may perform.

### DETAILED DESCRIPTION

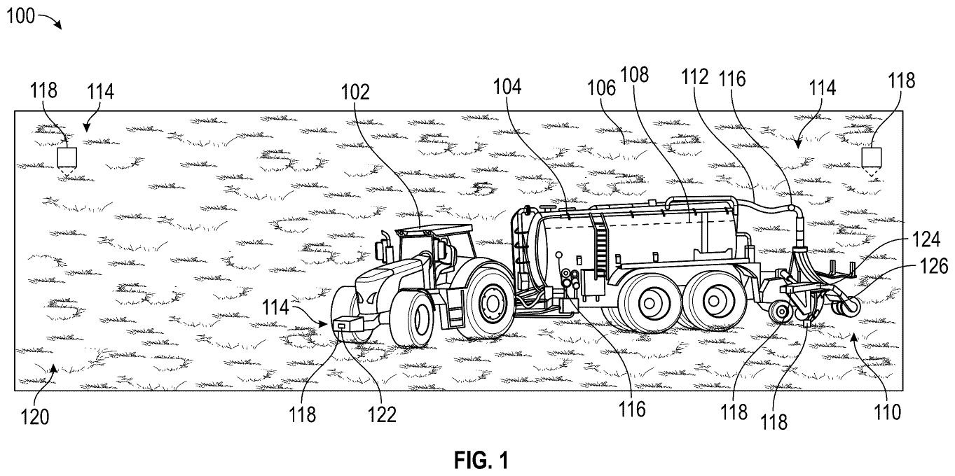

FIG. 1 is a side view of an example of an agricultural slurry application system 100. In an example, the agricultural slurry application system 100 includes a prime mover 102 (e.g., a tractor, truck, vehicle, or the like). In some examples, the prime mover 102 transports a slurry reservoir 104 across a field 106. For instance, the slurry reservoir 102 contains a quantity of an agricultural slurry 108, and a slurry applicator 110 (e.g., one or more knives, coulters, plough, nozzles, valves, pumps, tool bars or the like) applies the agricultural slurry 108 to the field 106. In another example, the reservoir 104 is stationary. For instance, the agricultural slurry is collected in a pool (e.g., pit, trough, containment vessel, or the like) located near the field 106. A conduit 112 (e.g., tube, pipe, line, channel, or the like) is in communication between the slurry reservoir 104 and the slurry applicator 110, and the agricultural slurry 108 flows from the slurry reservoir 104 to the slurry applicator 110 using the conduit 112. In some examples, the prime mover 102 drags the conduit 112 through the field, such as with conduit 112 communicating with stationary reservoir 104

The agricultural slurry application system 100 includes one or more sensors 114, for instance one or more of a slurry characteristic sensor 116 or a soil characteristic sensor 118. The slurry characteristic sensor 116 determines characteristics of the agricultural slurry 108, including (but not limited to) one or more of nitrogen concentration, ammonia concentration, ammonium concentration, phosphorous concentration, potassium concentration, or dry matter concentration of the agricultural slurry 108. In another example, the soil characteristic sensor 118 determines characteristics of soil 120 in the field 106. For example, the soil characteristic sensor 118 determines characteristics including (but not limited to) one or more of nitrogen concentration, ammonia concentration, ammonium concentration, phosphorous concentration, potassium concentration of the soil 120 in the field 106. In an example, the sensors 114 include (but are not limited to) one or more of an ultrasonic, laser, lidar, light emitting diode, hyperspectral, spectrometer sensors, or the like. For instance, the sensors 114 receive a signal (e.g., an electromagnetic wave, or the like), and the sensors 114 use the signal to determine characteristics of the soil (or the slurry).

In an example, the agricultural slurry application system 100 includes the sensors 114 coupled with other components of the system 100. For instance, the slurry characteristic sensor 116 is coupled with one or more of the slurry reservoir 104 or the conduit 112. Accordingly, the slurry characteristic sensor 116 determines characteristics of the agricultural slurry 108 in one or more of the slurry reservoir 104 or the conduit 112. Thus, the agricultural slurry application system 100 uses the slurry characteristic sensor 116 to determine characteristics of the agricultural slurry 108, and the slurry applicator 110 applies the agricultural slurry 108 to the soil 120 in the field 106 based on the determined characteristics of the agricultural slurry 108 (and application thresholds associated with a prescription map).

In another example, the system 100 includes the soil characteristic sensor 118 coupled with the prime mover 118. The soil characteristic sensor 118 optionally includes an optical sensor 122 to determine health of crops grown in the soil 120. For example, the system 100 uses the optical sensor 122 to perform spectrographic analysis of foliage to determine the health of crops grown in the soil 120. In yet another example, the soil characteristic sensor 118 is coupled with the slurry applicator 110. For instance, the soil characteristic sensor 118 is coupled along a tool bar 124 of the slurry applicator 110. The soil characteristic sensor 118 determines characteristics of the surface of the soil 120. In still yet another example, soil characteristic sensor 118 is coupled with an implement 126 (e.g., knife, coulter, or the like) of the slurry applicator 110 configured to penetrate soil. Accordingly, the soil characteristic sensor 118 determines characteristics of the soil 120 below the soil surface. In a further example, one or more soil characteristic sensors 118 are positioned in the field 106 to determine characteristics of the soil 120. Optionally, a plurality of soil characteristic sensors 118 are positioned in the field (permanently, semi-permanently, before or during a season or the like) to assess soil characteristics in various zones of the field. In another example, a technician moves the at least one soil characteristic sensor in the field and the sensor conducts sensing when positioned in the field.

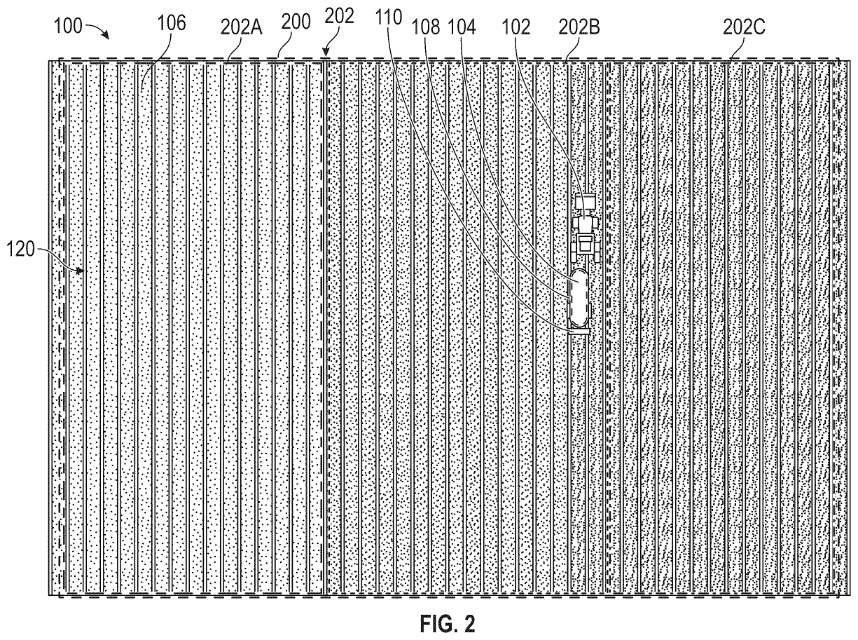

Optionally, the system 100 uses the in-ground soil sensors 118 and the soil sensors 118 coupled with the prime mover 102 to determine the soil characteristics. For instance, the in-ground soil sensors 118 determines an initial soil characteristic profile. The system 100 uses the soil sensors 118 coupled with the prime mover 102 to modify the initial soil characteristic profile. For example, the system 100 modifies the initial soil characteristic profile using the sensors 118 coupled with the prime mover 102 to update a prescription map (e.g., the prescription map 200, shown in FIG. 2). In an example, the in-ground soil sensors 118 provide a series of first readings for the initial soil characteristic. The system 100 uses on-board sensors 118 (e.g., sensors 118 coupled with the prime mover 102, or the like) to refine the initial soil characteristic profile based on measurements provided by the on-board sensors 118. For instance, the on-board sensors 118 enhance resolution of soil characteristic measurements because the on-board sensors 118 provide soil characteristic measurements that are remote from the in-ground sensor 118 and proximate to the prime mover 102 and its sensors 114. In another example, the on-board sensors 118 provide the first series of measurements, and the in-ground sensors are used to refine the measurements provided by the on-board sensors 118.

FIG. 2 is an aerial view of the agricultural slurry application system 100, including the prime mover 102 with the slurry reservoir 104 and the slurry applicator 110, within the field 106. The agricultural slurry application system 100 controls application of the agricultural slurry to the soil 120 in the field 106. In an example, the agricultural slurry application system 100 applies the agricultural slurry 108 according to a prescription map 200 (shown in FIG. 2 with long-length broken lines and overlaid on the field 106). For instance, the prescription map 200 has a plurality of zones 202(A-C), and the agricultural slurry application system 100 applies different quantities of agricultural slurry 108 to the plurality of zones 202, for instance based on target values included with the prescription map 200 zones 202. The plurality of zones 202 include a first zone 202A (shown with medium-length broken lines in FIG. 2), a second zone 202B (shown with dot-dash broken lines in FIG. 2), and a third zone 202C (shown with short-length broken lines in FIG. 2). FIG. 2 shows the prime mover 102 and the slurry applicator 110 in the second zone 202A of the prescription map 200.

In some examples, the agricultural slurry application system 100 controls application of the agricultural slurry 108 based on the location of one or more of the prime mover 102 or the slurry applicator 110 relative to the plurality of zones 202. For instance, the agricultural slurry application system 100 controls one or more of the prime mover 102 or the slurry applicator 110 to apply a first quantity (e.g., mass, weight, volume, flow rate, mass flow rate, volumetric flow rate, or the like) of agricultural slurry 108 within the first zone 202A (e.g., according to a prescription, prescription modified based on existing soil characteristics or the like) to achieve a first characteristic profile for the soil 120 in the first zone 202A. The first characteristic profile corresponds with a first set of one or more concentration values for one or more characteristics including, but not limited to, nitrogen, phosphorous, ammonia, ammonium, potassium or the like within the first zone 202A. Accordingly, the agricultural slurry 108 is applied to the soil 120 in the first zone 202A to alter (e.g., augment, change, enhance, supplement, or the like) characteristics of the soil 120 within the first zone 202A.

In another example, the agricultural slurry application system 100 controls one or more of the prime mover 102 or the slurry applicator 110 to apply a second quantity (e.g., mass, weight, volume, flow rate, mass flow rate, volumetric flow rate, or the like) of agricultural slurry 108 within the second zone 202B to achieve a second characteristic profile for the soil 120 in the second zone 202B. In an example, the system changes between the first quantity and the second quantity as the prime mover 102 approaches the second zone 202B (from the first zone 202A). The second characteristic profile corresponds with a second set of concentration values for one or more of nitrogen, phosphorous, ammonia, ammonium, or potassium within the second zone 202B. Thus, the agricultural slurry 108 is applied to the soil 120 in the second zone 202B to alter characteristics of the soil 120 within the second zone 202B. In yet another example, the agricultural slurry application system 100 controls one or more of the prime mover 102 or the slurry applicator 110 to apply a third quantity (e.g., mass, weight, volume, flow rate, mass flow rate, volumetric flow rate, or the like) of agricultural slurry 108 within the third zone 202C to achieve a third characteristic profile for the soil 120 in the third zone 202C. The third characteristic profile corresponds with a third set of concentration values for one or more of nitrogen, phosphorous, ammonia, ammonium, or potassium within the third zone 202C. Therefore, the agricultural slurry 108 is applied to the soil 120 in the third zone 202C to alter characteristics of the soil 120 within the third zone 202C.

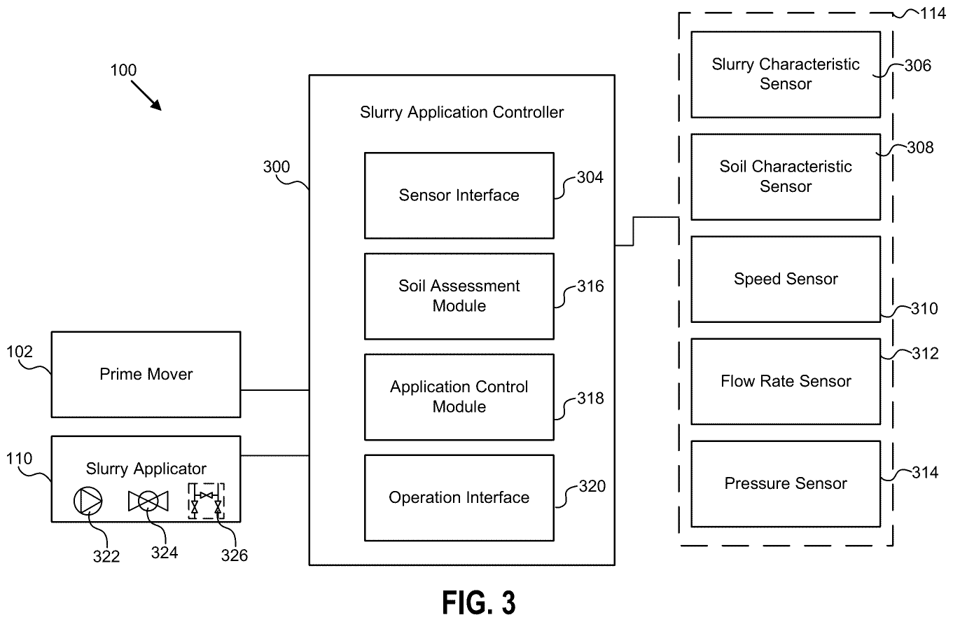

FIG. 3 is a schematic view of another example of the slurry application system 100. In an example, the slurry application system 100 includes a slurry application controller 300 and the one or more sensors 114. The slurry application controller 300 controls application of agricultural slurry with one or more of the prime mover 102 or the slurry applicator 110.

In another example, the slurry application controller 300 cooperates with the one or more sensors 114 to control application of the agricultural slurry. For instance, the slurry application controller 114 includes a sensor interface 304 that facilitates communication between the sensors 114 and the controller 114. In yet another example, the sensors 114 include one or more of a slurry characteristic sensor 306 or a soil characteristic sensor 308. The sensor interface 304 facilitates communication between the slurry characteristic sensor 306 and the soil characteristic sensor 308 with the remainder of the slurry application controller 300. As discussed herein, one or more values provided by the one or more sensors 306, 308 are provided to the controller 300, and the controller 300 controls target values (e.g., maintains or modulations), flow rate of slurry, prime mover speed or the like to achieve the target values. The slurry characteristic sensor 306 determines characteristics (e.g., nitrogen concentration, or the like) of agricultural slurry applied by the slurry applicator 110. In another example, the soil characteristic sensor 308 determines characteristics (e.g., nitrogen concentration, or the like) of soil (or crops grown in the soil). These characteristics facilitate the setting of target values of various characteristics, and control of the application of the slurry to achieve the target values, for instance within zones of the field.

In still yet another example, the sensor interface 304 communicates with a speed sensor 310. The speed sensor 310 determines speed (e.g., velocity, rate of travel, or the like) of the prime mover 102. The speed sensor 310 communicates the speed of the prime mover 102 to the slurry application controller 300 at the sensor interface 304. In an example, the slurry application controller 300 controls the speed (e.g., by feedback control) to a specified value corresponding to an application rate of the slurry. For instance, if the application rate is specified as 10 gallons of slurry per acre (or per minute), the application controller 300 controls the prime mover speed (and optionally the flow rate), with the speed sensor 310 providing feedback, to achieve the specified application rate.

In still yet another example, the slurry application controller 300 communicates with one or more of a flow rate sensor 312 or a pressure sensor 314. The flow rate sensor 312 determines flow of agricultural slurry through the slurry applicator 110. The pressure sensor 314 determines pressure of agricultural slurry applied by the slurry applicator 110. Accordingly, the slurry application controller 300 cooperates with the sensors 114 to determine characteristics of agricultural slurry (or characteristics of soil) and to monitor (and control) operation of the agricultural slurry application system 100 with one or more of the sensors 312, 314, for instance to apply slurry at a flow rate, pressure or the like based on slurry characteristics to achieve application thresholds in the field. In another example, the agricultural slurry is diluted before application to the field. For instance, the system 100 dilutes the agricultural slurry based on the slurry application value. Accordingly, the system 100 changes the slurry characteristics based on the slurry application value. For instance, the system 100 dilutes agricultural slurry to achieve the application thresholds in the field.

Referring again to FIG. 3, the slurry application controller 300 includes a soil assessment module 316. The soil assessment module 316 interprets determined values from the soil characteristic sensor 308 (or sensors, included with implements or vehicles or installed in the field), and the soil assessment module 316 modifies one or more operating parameters of the system 100 based on the values from the soil characteristic sensor 308. In one example, the soil assessment module 316 refines application thresholds for a prescription map based on soil assessment (e.g., decreasing or increasing application thresholds based on identified soil characteristics). For instance, the soil assessment module 316 modifies (e.g., updates, revises, change, or the like) the initial soil characteristic profile based on the determined values from the soil characteristic sensor 308. In an example, the initial soil characteristic profile is determined during the month of November in a first calendar year. The system 100 uses the soil characteristic sensor 308 to determine the characteristics of the soil, for instance to generate a present-day soil characteristic profile in the month of April in a second calendar year (following the first calendar year). The system 100 updates the initial soil characteristic profile to correspond with the present-day soil characteristic profile based on the determined change in characteristics of the soil (from November to April). In a further example, the soil characteristic sensors 308 determine soil characteristics during growth of crops in the soil. For instance, the soil characteristic sensors 308 determine the present-day soil characteristics in June. The system 100 is updated based on the change in soil characteristics from April to June. Thus, the system 100 monitors changes in soil characteristics using the soil characteristic sensor 318.

In another example, the slurry application controller 114 includes an application control module 318 that determines the specified quantity (e.g., mass, weight, volume, flow rate, mass flow rate, volumetric flow rate, or the like) of the agricultural slurry to apply with the system 100. The application control module 318 determines a slurry application value for the agricultural slurry application system 100. For instance, the slurry application value corresponds with the specified quantity (e.g., mass, weight, volume, flow rate, mass flow rate, volumetric flow rate, or the like) of agricultural slurry applied to soil. In another example, the application control module 318 cooperates with the sensor interface 304 to determine the slurry application value. For instance, the slurry application value is determined based on one or more of the slurry characteristics (determined with the slurry characteristic sensor 306), soil characteristics (determined with the soil characteristic sensor 308), the prescription map 200 (shown in FIG. 2), or the like.

In still yet another example, the slurry application controller 300 includes an operation interface 320 that implements the slurry application value determined by application control module 320. For instance, the operation interface 320 controls of one or more of the prime mover 102 (e.g., speed) or the slurry applicator 110 (e.g., nozzles, spouts, knives, coulters or the like and an associated flow rate or the like). For example, the operation interface 320 cooperates with the prime mover 102 to control speed of the prime mover 102 to apply a specified quantity of slurry (e.g., 10 gallons per acre of slurry with a speed of 10 mph). In another example, the operation interface 320 cooperates with the slurry applicator 110 to control a flow rate of agricultural slurry through the slurry applicator 110. For instance, the operation interface 320 cooperates with a valve 322, pump 324, distributor 326 or the like of the slurry applicator 110 to control flow rate of agricultural slurry through the slurry applicator 110 (or dilution of the agricultural slurry). In yet another example, the operation interface 320 controls one or more of the prime mover or the slurry applicator according to a comparison of determined slurry characteristics with one or more corresponding application thresholds.

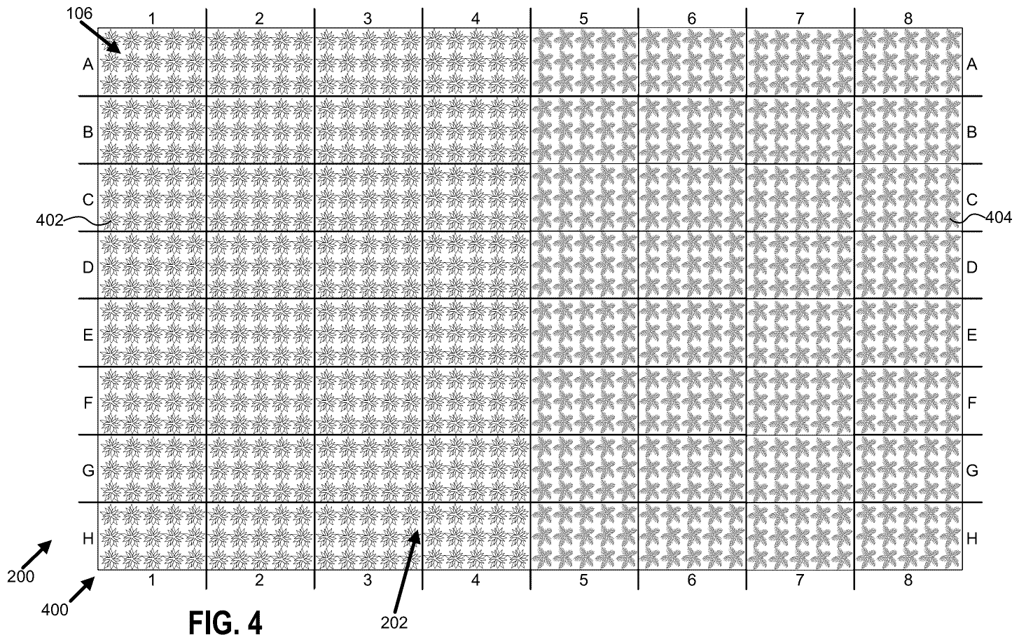

FIGS. 4-7 show the field 106 with the prescription map 200 overlaid. In an example, the agricultural slurry application system 100 uses the prescription map 200 to control one or more of the prime mover 102 or the slurry applicator 110 to achieve application thresholds (e.g., target soil characteristics) within each zone of the plurality of zones 202. For instance, FIG. 4 shows a first layer 400 of the prescription map 200 with a first application threshold 402 and a second application threshold 404 within the plurality of zones 202 (illustrated with different shading). In an example, FIG. 4 shows target soil characteristic profiles for a first set of crops grown in zones 1A-1H, 2A-2H, 3A-3H, 4A-4H; and a second set of crops grown in zones 5A-5H, 6A-6H, 7A-7H, 8A-8H.

For example, the application thresholds 402, 404 are associated with a target soil characteristic profile for each zone of the plurality of zones 202 (e.g., a specified value or combination of values for the soil). In another example, the target soil characteristic profile for a zone includes (but is not limited to) one or more of nitrogen concentration, ammonia concentration, ammonium concentration, phosphorous concentration, or potassium concentration for soil within the zone. The application thresholds 402, 404 are used by the system 100 as target values for the application of a specified quantity (e.g., mass, weight, volume, flow rate, mass flow rate, volumetric flow rate, or the like) of the agricultural slurry to soil and achieve a target characteristic profile for the soil in each zone within the plurality of zones 202.

In an example, the application threshold 402 is an active application threshold in correspondence with the prime mover 102 located within zones 1A-1H, 2A-2H, 3A-3H, or zones 4A-4H. The application threshold 404 is an inactive application threshold in correspondence with the prime mover 102 located within zones 1A-1H, 2A-2H, 3A-3H, or zones 4A-4H. In another example, the application threshold 404 is an active application threshold in correspondence with the prime mover 102 located within zones 5A-5H, 6A-6H, 7A-7H, or zones 8A-8H. The application threshold 402 is an inactive application threshold in correspondence with the prime mover 102 located within zones 5A-5H, 6A-6H, 7A-7H, or zones 8A-8H. The system 100 changes the active application threshold based on the location of the prime mover 102 relative to the field 106, shown in FIG. 1 (or the plurality of zones 202, shown in FIG. 2). For example, the system 100 changes the active application threshold from the first application threshold 402 to the second application threshold in correspondence with the prime mover moving from zone 7H to zone 8H. Accordingly, in some examples, the application thresholds are dynamic.

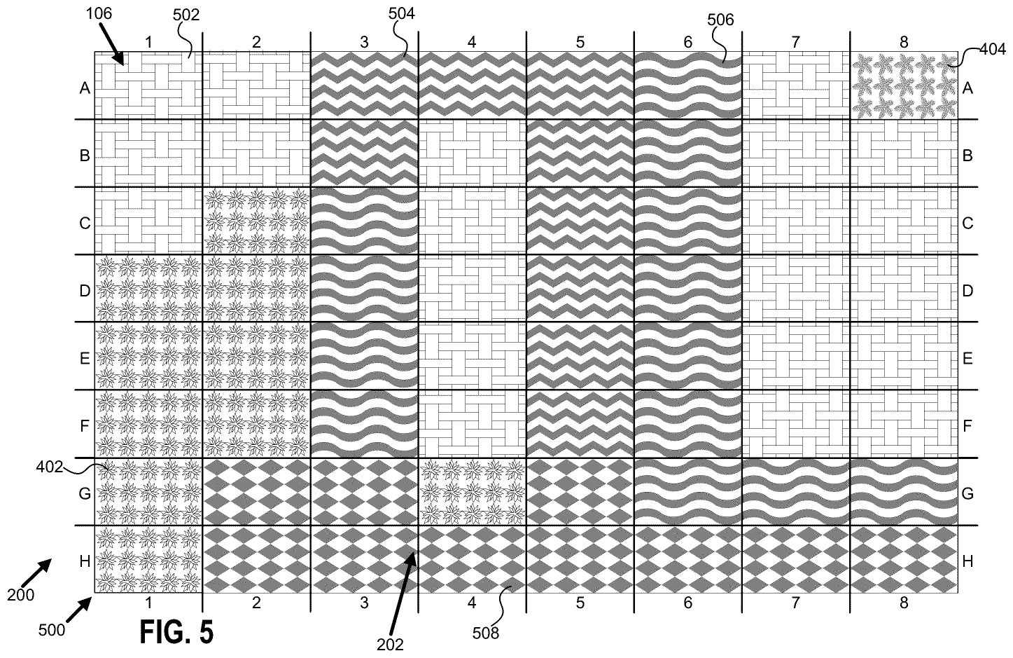

FIG. 5 shows a second layer 500 of the prescription map 200 with an initial characteristic profile for the soil in each zone of the plurality of zones 202. FIG. 5 shows the initial characteristic profile of the soil prior to application of an agricultural slurry to the soil. For example, zones 1D-1H, 2C-2F, 4G, and 8A have the target soil characteristic profile. Additionally, FIG. 5 shows a first soil characteristic profile 502 (for zone 1A and similarly hatched zones), a second soil characteristic profile 504 (for zone 3A and similar), a third soil characteristic profile 506 (for zone 6A and similar), a fourth characteristic profile 508 (for zone 4H and similar). The first and second application thresholds 402, 404 are shown within a plurality of zones 202 (e.g., 1D, 8A, and the like) and indicate in those zones that the application threshold is already met with the existing soil characteristics and application of slurry is not warranted in those zones. In some examples, the application thresholds are dynamic. For instance, the application thresholds optionally vary based on measured characteristics of the soil.

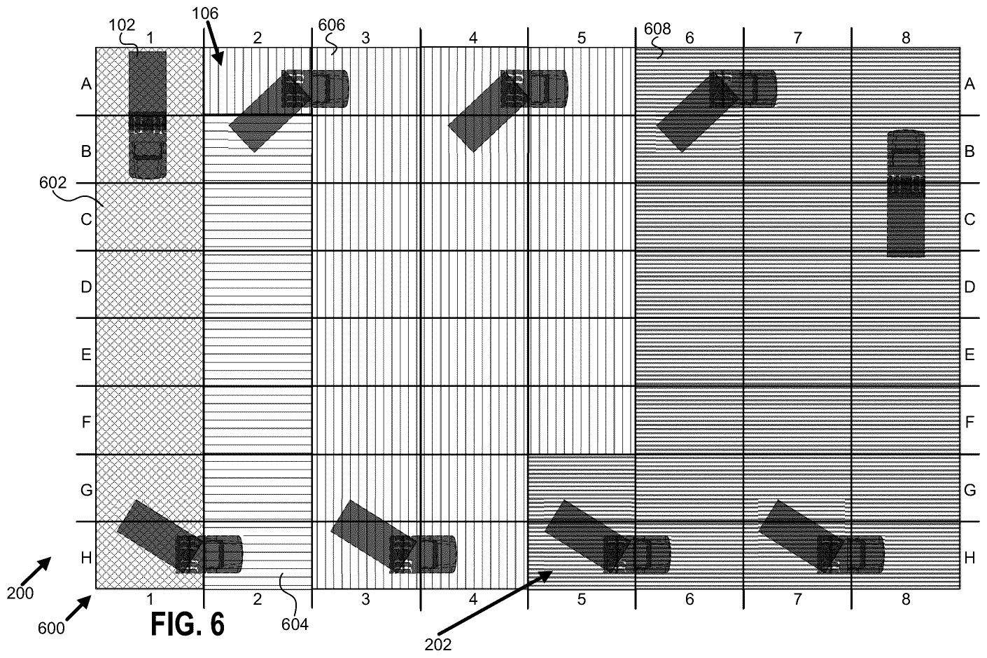

FIG. 6 shows a third layer 600 of the prescription map 200 with slurry characteristics of an agricultural slurry within each zone of the plurality of zones 202. As previously discussed herein, slurry characteristics vary, in some examples, as the slurry level in a tank, pit or the like changes, different constituents of the slurry are delivered to applicators or the like. The slurry characteristics are determined using the sensors 114, and as shown the sensors 114 detect the slurry characteristics and variations thereof while the prime mover 102 is moving in the field. The slurry characteristics of the slurry are not necessarily indexed to the corresponding zones. However, the slurry characteristics are shown as example inputs optionally used the application threshold and soil characteristics indexed to the corresponding zones. For example, in zone 3D having the associated target soil characteristic (e.g., application threshold) shown in FIG. 4 and the initial soil characteristic(s) shown in FIG. 5, the slurry available for application at 3D has the shown slurry characteristic(s) shown in FIG. 6. The system 100 uses the slurry characteristics at the incident zone as an input to control one or more of vehicle speed, application rate or the like to achieve a target soil characteristic profile within the incident zone. The system 100 updates the slurry characteristics as they change and conducts application as the slurry changes and according to the target soil characteristic profile (e.g., application threshold) and optionally the initial soil characteristic of the respective zones. In another example, FIG. 6 shows the prime mover 102 traversing the field 106 to apply agricultural slurry to the field 106.

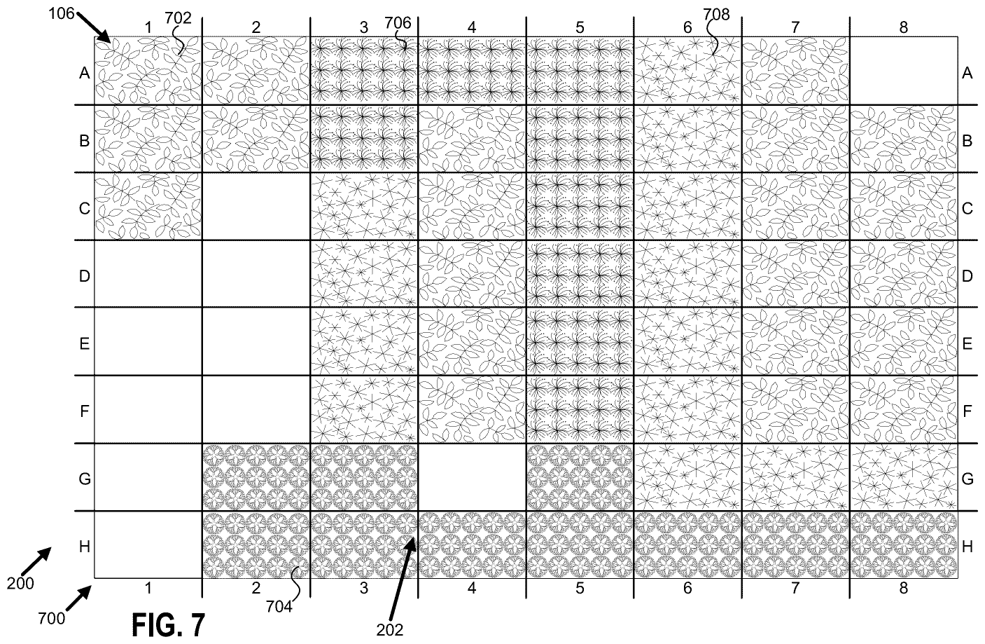

FIG. 7 shows a fourth layer 700 of the prescription map 200 with slurry application values for each zone of the plurality of zones 202. The slurry application value corresponds to a specified quantity (e.g., mass, weight, volume, flow rate, mass flow rate, volumetric flow rate, or the like) of agricultural slurry for application within each zone of the plurality of zones 202 to achieve application threshold(s) corresponding to a target soil characteristic profile. For instance, the application control module 318 (shown in FIG. 3) determines the slurry application value (e.g., one or more prime mover speed, slurry flow rate or the like) based on one or more of the initial soil characteristic profile (FIG. 5), the target soil characteristic profile (FIG. 4) having one or more application thresholds, the characteristics of the agricultural slurry (FIG. 6), or the like. Accordingly, the system 100 applies a specified quantity of agricultural slurry within each zone to achieve the target soil characteristic profile within each zone. In some examples, the slurry application values (e.g., first slurry application value 702, shown in FIG. 7) are determined based on a comparison of determined slurry characteristics (e.g., first slurry characteristic profile 602, shown in FIG. 6) with one or more corresponding application thresholds (e.g., first application threshold 402, shown in FIG. 4).

Referring to FIG. 4, the first layer 400 of the prescription map 200 shows one or more application thresholds, for instance the first and second application thresholds 402, 404. The applications thresholds 402, 404 are associated with target soil characteristic profiles within the zones 202. For example, zones 1A-1H, 2A-2H, 3A-3H, and 4A-4H have the first application threshold 402. Accordingly, the zones 1A-1H, 2A-2H, 3A-3H, and 4A-4H have a first target soil characteristic profile (e.g., nitrogen concentration of 30 parts per million, and potassium concentration of parts per million). Zones 5A-5H, 6A-6H, 7A-7H, and 8A-8H have the second application threshold 404. Thus, the zones 5A-5H, 6A-6H, 7A-7H, and 8A-8H have a second target soil characteristic profile (e.g., nitrogen concentration of 23 parts per million, and potassium concentration of 18 parts per million).

Referring to FIG. 5, the second layer 500 of the prescription map 200 shows one or more initial soil characteristic profiles, for instance the different initial soil characteristic profiles 502, 504, 506, and 508. FIG. 5 shows different zones within the field 106 have different soil characteristic profiles, for instance prior to application of an agricultural slurry to the field 106. In an example, zones 1A-1C, 2A-2B, 4B-4F, 7A-7F, and 8B-8F have the first soil characteristic profile 502 (first hatching). Zones 3A-3F, 4A, and 5A-5F have the second soil characteristic profile 504 (second hatching). Zones 3C-3F, 6A-6G, 7G, and 8G have the third soil characteristic profile 506 (third hatching). Zones 2G, 2H, 3G, 3H, 4H, 5G, 5H, 6H, 7H, and 8H have the fourth characteristic profile 508 (fourth hatching). As previously described, the zones 502-508 have different initial soil characteristics. The soil characteristic profiles 502-508 are an optional input to facilitate control of application of the agricultural slurry to achieve application thresholds (e.g., that provide soil having the first and second application thresholds 402, 404 shown in FIG. 4.

Referring to FIG. 6, and in some examples, the characteristics of agricultural slurry applied to the field 106 changes during application of the slurry to the field 106. For instance, FIG. 6 shows the third layer 600 of the prescription map 200 showing characteristics of the slurry within the plurality of zones 202. In an example, the nitrogen concentration for agricultural slurry changes in accordance with removal of the agricultural slurry from the slurry reservoir 104 (shown in FIG. 1). For instance, the nitrogen concentration for agricultural slurry changes as the agricultural slurry is applied to the field 106. FIG. 6 shows zones the prime mover traversing zones 1A-1H, with zones 1A-1H having a first slurry characteristic profile 602. The prime mover turns at zone 1H to enter zone 2H. Zones 2B-2H have a second slurry characteristic profile 604. The prime mover 102 turns at zone 2A and enters zone 3A. The prime mover continues through the zones 202, and applies specified quantities of agricultural slurry within the zones 202. Zones 3A-3H, 4A-4H, and 5A-5F show the agricultural slurry applied to the field 106 has a third slurry characteristic profile 606. Zones 5G, 5H, 6A-6H, 7A-7H, and 8A-8H show the agricultural slurry having a fourth slurry characteristic profile 608. Accordingly, in some examples, the characteristics of agricultural slurry change as slurry is removed from its containment (e.g., the slurry reservoir 104, shown in FIG. 1) and applied to the field 106.

Referring to FIG. 7, the fourth layer 700 of the prescription map 200 shows slurry application values corresponding to specified quantities of agricultural slurry applied within the zones 202. For example, the soil assessment module 316 determines the slurry application values using one or more of the slurry application thresholds (e.g., the application thresholds 402, 404 shown in FIG. 4), the initial soil characteristic profiles (e.g., first soil characteristic profiles 502-508, shown in FIG. 5), or the slurry characteristic profiles (e.g., the slurry characteristic profiles 602-608 shown in FIG. 6). The slurry application controller 300 determines slurry application values by comparing the slurry characteristic profiles with one or more of the slurry application thresholds or the initial soil characteristics associated with a zone the prime mover 102 and implement are treating. For instance, the application threshold is a target value and the slurry application value is set to achieve the application threshold based on the slurry characteristics, for instance measured with the slurry characteristic sensor 306 (shown in FIG. 3). In another example, the application threshold is the target value and is refined based on the initial soil characteristics (see FIG. 5). The slurry application value is set to achieve the refined application threshold based on slurry characteristics and the refined application threshold.

In an example, zones 1A-1C, 2A-2B, 4B-4F, 7A-7G, and 8B-8G have a first slurry application value 702 (first hatching). Accordingly, the slurry application controller 300 controls one or more of the prime mover 102 or the slurry applicator 110 to apply a first quantity of agricultural slurry within zones 1A-1C, 2A-2B, 4B-4F, 7A-7G, and 8B-8G. Thus, the agricultural slurry application system 100 applies agricultural slurry to the field 106 to bring the initial soil characteristic profile 502 (FIG. 5) within the zones 1A-1C, 2A-2B, 4B-4F, 7A-7G, and 8B-8G from the initial soil characteristic profile (shown in FIG. 5) to the target soil characteristic profiles associated with slurry application threshold 402, 404—shown in FIG. 4.

In yet another example, the fourth layer 700 of the prescription map 200 shows zones 2G, 2H, 3G, 3H, 4H, 5G, 5H, 6H, 7H, and 8H have a second slurry application value 704 (second hatching). Accordingly, the slurry application controller 300 controls one or more of the prime mover 102 or the slurry applicator 110 to apply a second quantity of agricultural slurry within zones 2G, 2H, 3G, 3H, 4H, 5G, 5H, 6H, 7H, and 8H. Thus, the agricultural slurry application system 100 applies agricultural slurry to the field 106 to bring the soil characteristic profile within the zones 2G, 2H, 3G, 3H, 4H, 5G, 5H, 6H, 7H, and 8H from the initial soil characteristic profile 508 (shown in FIG. 5) to the target soil characteristic profiles associated with slurry application thresholds 402, 404—shown in FIG. 4.

In still yet another example, the fourth layer 700 of the prescription map 200 shows zones 3A, 3B, 4A, 5A-5F have a third slurry application value 706 (third hatching). Accordingly, the slurry application controller 300 controls one or more of the prime mover 102 or the slurry applicator 110 to apply a third quantity of agricultural slurry within zones 3A, 3B, 4A, 5A-5F. Thus, the agricultural slurry application system 100 applies agricultural slurry to the field 106 (according to a slurry application value) to bring the soil characteristic profile within the zones 3A, 3B, 4A, 5A-5F from the initial soil characteristic profile 504 (shown in FIG. 5) to the target soil characteristic profiles associated with slurry application threshold 402, 404—shown in FIG. 4.

In a still yet further example, the fourth layer 700 of the prescription map 200 shows zones 6A-6G, 7G, and 8G have a fourth slurry application value 708 (fourth hatching). Accordingly, the slurry application controller 300 controls one or more of the prime mover 102 or the slurry applicator 110 to apply a fourth quantity of agricultural slurry within zones 6A-6G, 7G, and 8G. Thus, the agricultural slurry application system 100 applies agricultural slurry to the field 106 to bring the soil characteristic profile within the zones 6A-6G, 7G, and 8G from the initial soil characteristic profile 506 (shown in FIG. 5) to the target soil characteristic profiles associated with slurry application threshold 402, 404—shown in FIG. 4. In another example, the fourth layer 700 of the prescription map 200 shows zones 1D-1H, 2C-2F, 4G, and 8A are blank. Accordingly, the slurry application value is zero within zones 1D-1H, 2C-2F, 4G, and 8A. The slurry application value is zero within zones 1D-1H, 2C-2F, 4G, and 8A because the initial soil characteristic profile 402 (shown in FIG. 5) corresponds with the respective target soil characteristic profiles associated with slurry application threshold 402, 404—shown in FIG. 4. Thus, the system agricultural slurry application system 100 refrains from applying agricultural slurry in zones 1D-1H, 2C-2F, 4G, and 8A because the target soil characteristic profile is already achieved for zones 1D-1H, 2C-2F, 4G, and 8A. In an example, the slurry application controller 300 controls one or more of the prime mover 102 or the slurry applicator 110 to refrain from applying agricultural slurry within zones 1D-1H, 2C-2F, 4G, and 8A—because the slurry application value is zero within those zones. Optionally, the operator or autonomous prime mover 102 is given instructions or notification that movement through those portions of the field is unnecessary and instead the prime mover 102 may move on to the next zone with prescribed treatment.

Referring to FIG. 3, the agricultural slurry application system 100 uses the slurry application values described herein to control one or more of the prime mover or the slurry applicator 110. For instance, the slurry application controller 300 controls the prime mover 102 to speed up (or slow down) the prime mover 102 to change the rate of application of the agricultural slurry within a zone (and accordingly change the amount of agricultural slurry applied within that zone) based on the slurry application value for that zone. In another example, the slurry application controller 300 controls the slurry applicator 102 to modulate flow (increase, decrease or maintain flow) of agricultural slurry through the slurry applicator 110. Increasing flow (or decreasing flow) through the slurry applicator 110 correspondingly changes the rate of application of the agricultural slurry within a zone (and accordingly changes the amount of agricultural slurry applied within that zone) in compliance with the slurry application value for that zone. Thus, the agricultural slurry application system 100 determines characteristics of one or more of the agricultural slurry or soil within the field 106 (shown in FIG. 1) to achieve a target soil characteristic profile within each zone of the plurality of zones 202 (shown in FIG. 2).

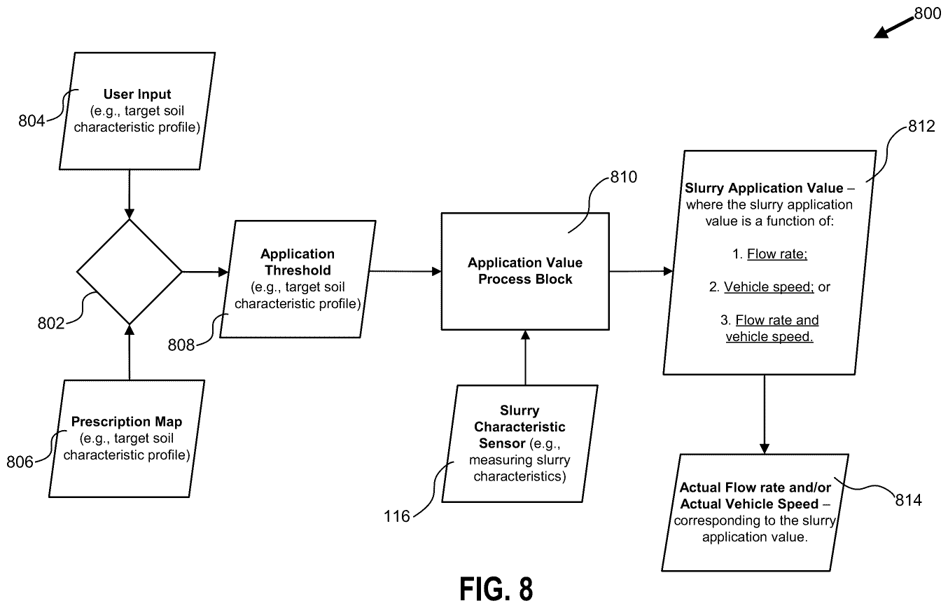

FIG. 8 is a schematic diagram of an example algorithm 800 for determining a slurry application value. The agricultural slurry application system 100 (shown in FIG. 1), in an example, implements the algorithm 800 to apply agricultural slurry with the slurry applicator 110 (also shown in FIG. 1). In an example, the slurry application value is a function of one or more of flowrate through the slurry applicator or vehicle speed—and is based on slurry characteristics, prescription maps, or the like. For instance, a first decision block 802 has a user input 804 and a prescription map 806 input. The user input 804 (e.g., 10 ppm/acre, 10 ppm/zone, or the like) corresponds to remote or onboard vehicle input value (or values) by a user of one or more characteristics evaluated with the decision block 802. The characteristics include values that correspond to an application threshold. The prescription map 806 (e.g., 30 ppm/acre, 30 ppm/zone, or the like) is an example of another input value (or values) including one or more characteristics evaluated with the decision block 802. In an example, the prescription map 806 includes one or more layers (e.g., the first layer 400, shown in FIG. 4). For example, the prescription map 200 (shown in FIG. 4) has prescription values for zones 202 of the of the field 106. The output of the decision block 802 is an application threshold 808 for the agricultural slurry application system 100 that is specified to satisfy the prescription map 806 (for instance one or more target soil characteristics) or the user input 804. For example, the user input 804 and the prescription map 806 provide values that become the application threshold 808. The decision block 802 evaluates these values and selects one of the values to become the application threshold 808, such as 9000 N₂ ppm/acre (converted to 5454 ppm/min or similar based on boom width and prime mover speed). The application threshold 808 (e.g., a specified or desired soil characteristic profile) optionally varies throughout an agricultural field depending upon either (or both) of the prescription map or the user input. For example, in a prescription map different target soil characteristics are indexed to zones of a field (e.g., 8000 N₂ ppm/acre in Zone 1A-D, 8500 in Zone 1E-2B and so on).

In one example, the user input 804 is provided in place of the prescription map 806, overrides or modifies the prescription map 806, or the like. For example, the decision block 802 evaluates whether the user input 804 is provided for a specified portion (e.g., a first zone, such as zone 1A in FIG. 4) of the agricultural field and if the input 804 is provided for a specified portion assigns a higher priority to the user input 804. The decision block 802 selects the user input 804 for the specified portion of the agricultural field based on the higher priority, and selects the prescription map 806 for other portions of the agricultural field (unless a higher priority user input 804 is provided for the other portions).

In another example, the algorithm 800 includes an application value process block 810. The block 810 includes one or more inputs, for instance the application threshold 808 (provided as an output from decision block 802) and slurry characteristics provided by the slurry characteristic sensor 116. Example slurry characteristics are shown in FIG. 6. The slurry characteristic sensor 116 determines characteristics of agricultural slurry, including (but not limited to) one or more of nitrogen concentration, ammonia concentration, ammonium concentration, phosphorous concentration, potassium concentration, or dry matter concentration of the agricultural slurry 108. Slurry characteristics (e.g., N₂ 30 ppm/gallon or 5430 ppm/min based on boom width and prime mover speed, N₂ 50 ppm/gallon or 9050 ppm/min, or the like) vary, in some examples, as the slurry level in a tank, pit or the like changes, different constituents of the slurry are delivered to applicators or the like.

The block 810 evaluates the slurry characteristics and the application threshold to determine a slurry application value 812 (e.g., a flow rate, speed of the vehicle, both or the like). FIG. 7 shows examples of slurry application values (shown with varied graphics in the zones) for the agricultural field 106. The slurry application value 812 is an output for the block 810. For instance, the block 810 synthesizes slurry characteristic measurements (e.g., from the sensor 116) and the application threshold 808 to determine the slurry application value 812 (e.g., 100 gallons of slurry/acre or 60 gallons of slurry/minute, 315 gallons of slurry/acre or 190 gallons of slurry/minute, or the like). In one representative example, the relationship between the application threshold, slurry characteristics provided by slurry characteristic sensor 116, and slurry application value 812 are determined with example Equations 1-2B and implemented with the application value process block 810. For Equation 1

Application Rate Adjustment Value=(Slurry Characteristic/Application Threshold)*100 Equation 1:

Application Rate Adjustment Value=(5430/5454)*100=99.5% Equation 1 (solved):

The Slurry Application Value is then determined based on a modification of a base flow rate, speed or the like of the prime mover by the Application Rate Adjustment Value (or its inverse). In one example, the base flow rate is 300 gal/acre or 181 gal/min with the prime mover traveling at 5 mph with a 60 foot boom width. Equations 2A-D provides example modifications.

Slurry Application Value=Base Application Flow Rate*(1+0.05) Equation 2A:

Slurry Application Value=181 gal/min*1.05=190 gal/min Equation 2A (solved):

Slurry Application Value=300 gal/acre*1.05=315 gal/acre Equation 2A (solved):

Slurry Application Value=Base Application Speed*(0.995) Equation 2B:

Slurry Application Value=5 mph*(0.995)=4.975 mph Equation 2B (solved):

Accordingly, in an example, the slurry application value 812 is generated from the application threshold and the slurry characteristics measured with the slurry characteristic sensor 116. For instance, in this example, the slurry application value 812 is the product of the slurry characteristic divided by the application threshold. This provides the Application Rate Adjustment Value that is applied (as its value or an inverse value) to one or more of the base flow rate of the slurry or base prime mover speed to adjust the flow rate or speed to the determined Slurry Application Values (as noted in the first example above, 190 gal/min, 315 gal/acre or 4.975 mph).

Another representative example includes similar base values for the prime mover, such as a base (or original flow rate) of 300 gal/acre (181 gal/min) and 5 mph, and an application threshold for N₂ of 9000 ppm/acre (5454 ppm/min). In this example, the slurry characteristic measured with the slurry characteristic sensor is 50 ppm/gal (9050 ppm/min) instead of the 30 ppm/gal of the previous example.

For instance, the relationship between the application threshold, slurry characteristics provided by slurry characteristic sensor 116, and slurry application value 812 are determined with example Equations 1-2B and implemented with the application value process block 810. For Equation 1

Application Rate Adjustment Value=(Slurry Characteristic/Application Threshold)*100 Equation 1:

Application Rate Adjustment Value=(9050/5454)*100=165% Equation 1 (solved):

The Slurry Application Value is then determined based on a modification of a base flow rate, speed or the like of the prime mover by the Application Rate Adjustment Value (or its inverse). In one example, the base flow rate is 300 gal/acre or 181 gal/min with the prime mover traveling at 5 mph with a 60 foot boom width. Equations 2A-D provides example modifications.

Slurry Application Value=Base Application Flow Rate*(1−0.650) Equation 2A:

Slurry Application Value=181 gal/min*0.35=63 gal/min Equation 2A (solved):

Slurry Application Value=300 gal/acre*0.35=105 gal/acre Equation 2A (solved):

Slurry Application Value=Base Application Speed*(1.65) Equation 2B:

Slurry Application Value=5 mph*(1.65)=8.25 mph Equation 2B (solved):

Accordingly, in an example, the slurry application value 812 is generated from the application threshold and the slurry characteristics measured with the slurry characteristic sensor 116. For instance, in this example, the slurry application value 812 is the product of the slurry characteristic divided by the application threshold. This provides the Application Rate Adjustment Value that is applied (as its value or an inverse value) to one or more of the base flow rate of the slurry or base prime mover speed to adjust the flow rate or speed to the determined Slurry Application Values (as noted in the first example above, 190 gal/min, 315 gal/acre or 4.975 mph).

In another example, the slurry application value 812 is the multiplicative product of the application threshold and the slurry characteristics. In yet another example, the slurry application value 812 corresponds to a difference between the application threshold and the slurry characteristics. In a further example, one or more of the user input 804, prescription map 806 values, and slurry characteristics measured with the slurry characteristic sensor 116 may, in some examples, vary as the application vehicle moves through the field. Accordingly, the process block 810 incorporates these variations and generates updated slurry application values to thereby apply slurry in a manner that improves husbandry (e.g., the system evaluates the field 106 and inputs in an ongoing manner and varies slurry application to implement those inputs and evaluated characteristics of the field). In yet another example, the speed of the prime mover is included in the generation of the slurry application value 812. For instance, speed is a gain (multiplier) that accordingly decreases or increases the slurry application value 812 with slower and higher speeds, respectively.

The slurry application value 812, in one example, corresponds with one or more of a flow rate through the slurry applicator 110 or speed of the prime mover, or the like. For instance, the system 100 uses the slurry application value 812 to control one or more of the prime mover 102 or the slurry applicator 110 and correspondingly apply an agricultural slurry in a specified quantity to the field 114 (shown in FIG. 1). Thus, in one example, the system uses the algorithm 800 to determine the slurry application value 812—and the system 100 applies agricultural slurry at a specified flow rate to the field 106 (shown in FIG. 1) based on the slurry application value 812 and the component values that are used for generation of the slurry application value 812 (e.g., user input, prescription map characteristics, slurry characteristic sensor measurements or the like). In another example, the agricultural slurry is applied with a static flow rate and the speed of the prime mover is controlled as the slurry application value 812 to correspondingly apply the slurry in a manner based on the input values. Optionally, the slurry application value 812 includes each of a specified flow rate of the slurry and vehicle speed (or functions of the same), and speed and flow rate are controlled cooperatively to apply the slurry. The output flow rate or vehicle speed are both shown at 814 in FIG. 8, though the algorithm includes outputs that are one of flow rate or vehicle speed, as well as both.

In yet another example, at least a first application threshold (potentially derived from a target soil characteristic or target soil characteristic profile) is provided to the algorithm 800 (e.g., using a console, or the like). For example, the algorithm optionally uses first and second application thresholds to determine the slurry application value 812. The algorithm 800 determines the first and second application thresholds based on the inputs to decision block 802. The first application threshold (including one or more thresholds) is optionally derived from various inputs. For instance, a prescription map having a target soil characteristic profile and a user input target soil characteristic are example inputs for the decision block 802. These inputs are in various examples preferentially selected (e.g., with user input target soil characteristic having a higher priority) or synthesized to provide the application threshold. The algorithm 800 uses the first application threshold to determine a slurry application value 812.

In yet another example, the algorithm 800 uses a second application threshold to determine the slurry application value 812. For instance, a user may specify (e.g., establish, set, fix, instruct, or the like) a target soil characteristic for a single zone (e.g., zone 1A, shown in FIG. 4, or the like) within the plurality of zones 202 (shown in FIG. 2). In this example, the algorithm 800 determines the first and second application thresholds based on the inputs to decision block 802. The algorithm 800 uses the first application threshold for the single zone (e.g., zone 1A, or the like), and uses the second application threshold for the remaining zones in the plurality of zones 202.

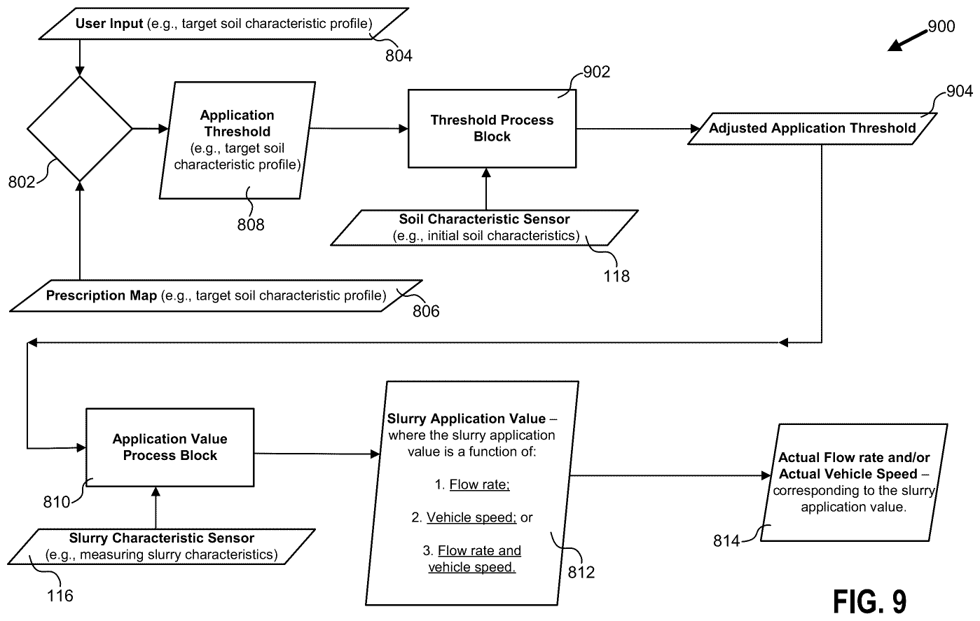

FIG. 9 is a schematic diagram of another example of an algorithm 900 for determining a slurry application value. The algorithm 900 includes portions of the algorithm 800 (shown in FIG. 8). In an example, the algorithm 900 includes decision block 802 and application value process block 810. For instance, the decision block 802 (also shown in FIG. 8) has the user input 804 and the prescription map 806 (e.g., a layer of the prescription map 200, shown in FIG. 4, or the like). The output of the decision block 802 is the application threshold 808.

The algorithm 900 includes a threshold process block 902. For example, the threshold process block 902 receives the application threshold 808 as an input from the decision block 802. In another example, the block 902 receives soil characteristics, for example initial soil characteristics, from a soil characteristic sensor. For instance, one or more in-ground sensors 118 (e.g., a sensor positioned in a field that is stationary, or the like) or on-board sensors 118 (e.g., a soil sensor coupled with a prime mover that is mobile, or the like) provide the soil characteristics to the threshold process block 902. In yet another example, the soil characteristics are obtained from a layer of the prescription map 200, for example from the second layer 500 shown in FIG. 5.

The block 902 determines an adjusted application threshold 904 using the soil characteristics (provided by sensors 118) and the application threshold 808 (e.g., an initial, non-adjusted application threshold, or the like) provided by the decision block 802. For instance, the algorithm 900 uses the threshold process block 902 to account for existing soil conditions in the field 106 (shown in FIG. 4) and provide the adjusted application threshold 904. In an example, the initial soil characteristics include nitrogen at 35 parts per million within an individual zone (e.g., zone 1A—shown in FIG. 5, or the like) of the plurality of zones 202 (shown in FIG. 2). The (initial) application threshold includes nitrogen at 50 parts per million within the individual zone (e.g., zone 1A—shown in FIG. 4, or the like). The algorithm 900 adjusts the (initial) application threshold using the initial soil characteristics. For example, the adjusted application threshold corresponds to a difference between the (initial) application threshold and the initial soil characteristics provided by sensors 118. Accordingly, if the sensor 118 is moving through the soil, then the sensor 118 can measure N₂ ppm as a value of X N₂ ppm/min. In an example, the sensor 118 measures 1230 N₂ ppm/min. With the example Application Threshold in the previous practical examples of 5454 ppm/min, the threshold is adjusted to an adjusted application threshold. For instance, the adjusted application threshold equals the difference between the application threshold (5454 ppm/min) and the soil characteristics measured by the sensor 118 (1230 ppm/min). Accordingly, in this example, the adjusted application threshold equals 4224 ppm/min.

The block 902 provides the adjusted application threshold 904 as an output. Thus, in some examples, the application thresholds are dynamic. For instance, the application thresholds optionally vary based on measured characteristics of the soil.

In an example, the algorithm 900 includes the application value process block 810 receiving the adjusted application threshold as an input (from threshold process block 902). As discussed herein, the application value process block 810 receives slurry characteristics as an input from the slurry characteristic sensor 116. The algorithm 900 uses the adjusted application threshold and the slurry characteristics to determine the slurry application value 812. For instance, the decision block 904 evaluates the slurry characteristics (provided by sensors 118) and the adjusted application threshold (provided by threshold process block 902) to determine the slurry application value 812. The slurry application value 812 is an output for the application value process block 810. For instance, the block 810 synthesizes slurry characteristic measurements and the adjusted application threshold to determine the slurry application value 812.

Accordingly, in an example, the slurry application value is generated from the adjusted application threshold and the slurry characteristics measured with the slurry characteristic sensor 116. For instance, in one example, the slurry application value 812 is the product of the adjusted application threshold divided by the slurry characteristics. In another example, the slurry application value 812 is the multiplicative product of the adjusted application threshold and the slurry characteristics. In yet another example, the slurry application value 812 corresponds to a difference between the adjusted application threshold and the slurry characteristics. In another example, the relationship between the application threshold, slurry characteristics provided by slurry characteristic sensor 116, and slurry application value 812 are determined with example Equations 1-2B and implemented with the application value process block 810.

As described herein, the system 100 uses the slurry application value 812 to control one or more of the prime mover 102 or the slurry applicator 110 and apply an agricultural slurry to the field 106 (shown in FIG. 1). Thus, in one example, the system uses the algorithm 900 to determine the slurry application value 812 using an application threshold adjusted for initial soil conditions in the field—and the system 100 applies an agricultural slurry to the field 106 (shown in FIG. 1) based on the slurry application value 812. In some examples, the system 100 minimizes differences between the target soil characteristic profile (e.g., first application threshold 402 associated with a first target soil characteristic profile, shown in FIG. 4) and the determined soil characteristics (e.g., first soil characteristic profile 502, shown in FIG. 5) by applying the agricultural slurry according to the slurry application value 812 (e.g., the first slurry application values 702 shown in FIG. 7, or the like). For instance, the system 100 applies slurry at the specified slurry application value to enhance soil characteristics to satisfy (achieve) the adjusted application threshold.

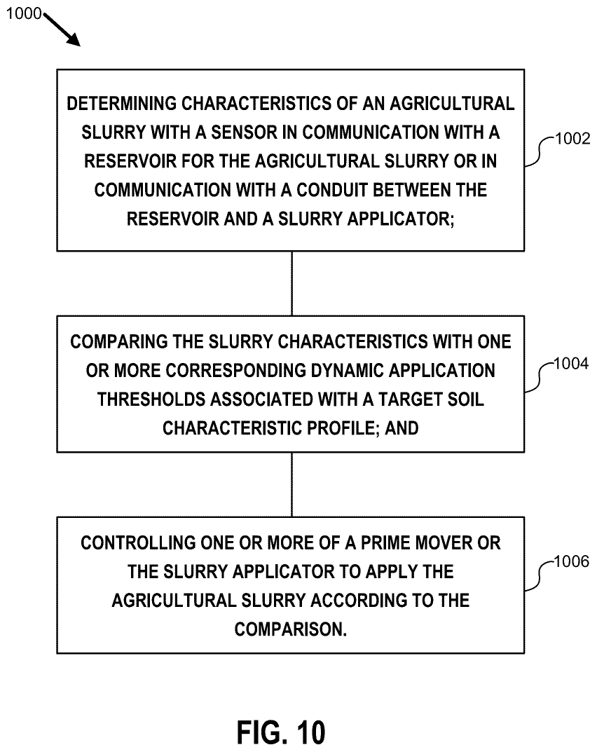

FIG. 10 is one example of a method 1000 for applying an agricultural slurry. In describing the method 1000, reference is made to one or more components, features, functions and operations previously described herein. Where convenient, reference is made to the components, features, operations and the like with reference numerals. The reference numerals provided are exemplary and are not exclusive. For instance, components, features, functions, operations and the like described in the method 1000 include, but are not limited to, the corresponding numbered elements provided herein and other corresponding elements described herein (both numbered and unnumbered) as well as their equivalents.

The method 1000 includes at 1002 determining characteristics of an agricultural slurry with a sensor 114. In an example, the sensor 114 is in communication with a slurry reservoir 104. In another example, the sensor 114 is in communication with a conduit 112 between the reservoir 114 and a slurry applicator 110. At 1004, the method 1000 includes comparing characteristics of the slurry with one or more corresponding application thresholds, for instance a dynamic application threshold. The application thresholds are associated with a target soil characteristic profile. The method 1000 includes at 1006 controlling one or more of a prime mover 102 or the slurry applicator 110 to apply agricultural slurry according to the comparison of the slurry characteristics with the application thresholds.

Several options for the method 1000 follow. For instance, the sensors 114 determine characteristics of soil in the field 106. In another example, the characteristics of the soil are compared to a target soil characteristic profile. The method 1000 optionally includes controlling one or more of the prime mover 102 or the slurry applicator 110 according to the comparison of soil characteristics with the target soil characteristic profile.

In yet another example, a slurry application value is determined based on the comparison of the slurry characteristics with the corresponding application thresholds. In some examples, the application thresholds are included in a prescription map 200. A specified quantity of the agricultural slurry is applied within each zone of the field 106 based on a comparison of the determined one or more slurry characteristics with the prescription map 200. For instance, the system 100 minimizes differences between a target soil characteristic profile and the determined soil characteristics. The system 100 applies agricultural slurry to the soil to change the characteristics of the soil (and minimize differences between those characteristics and the target soil characteristic profile).

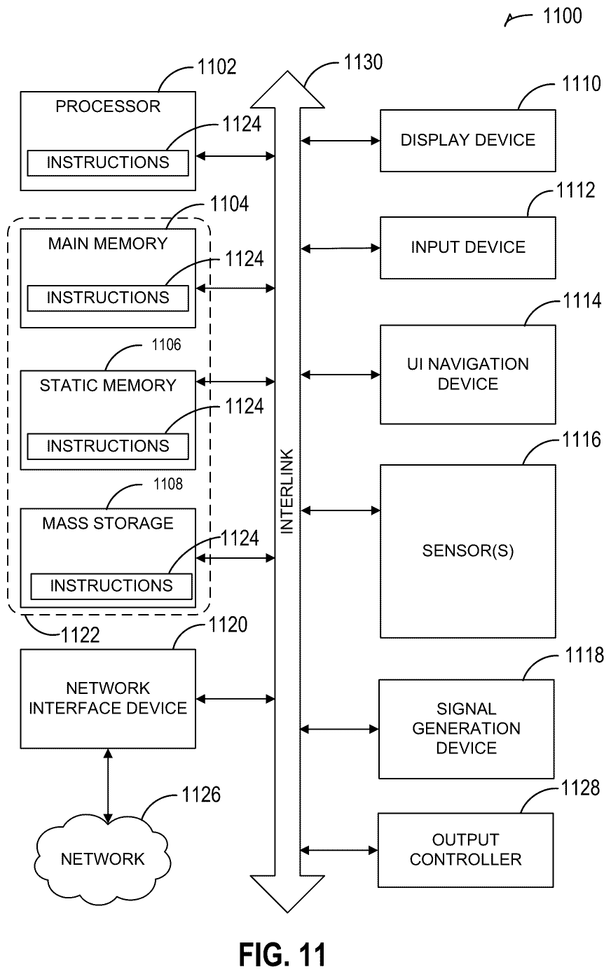

FIG. 11 illustrates a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), unified extensible firmware interface (UEFI), etc.) 1106, and mass storage 1108 (e.g., hard drive, tape drive, flash storage, or other block devices) some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine readable medium 1122 on which is stored one or more sets of data structures or instructions 1124 (e.g., software) embodying or utilized by any one or more of the techniques or functions described herein. The instructions 1124 may also reside, completely or at least partially, within any of registers of the processor 1102, the main memory 1104, the static memory 1106, or the mass storage 1108 during execution thereof by the machine 1100. In an example, one or any combination of the hardware processor 1102, the main memory 1104, the static memory 1106, or the mass storage 1108 may constitute the machine readable media 1122. While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine readable medium.

### Various Notes & Aspects

Example 1 is an agricultural slurry application system, comprising: a slurry reservoir configured to contain a quantity of the agricultural slurry; a slurry applicator configured to apply the agricultural slurry to soil, the agricultural slurry received from the slurry tank, and the slurry applicator is configured for coupling with a prime mover; a conduit in communication between the slurry reservoir and the slurry applicator; a slurry characteristic sensor coupled with one or more of the slurry reservoir or the conduit, wherein the slurry characteristic sensor is configured to determine one or more slurry characteristics; and a slurry application controller configured to control application of the agricultural slurry with one or more of the prime mover or the slurry applicator, the slurry application controller includes: a characteristic comparator configured to compare the determined one or more slurry characteristics with one or more corresponding application thresholds of a prescription map, the prescription map having a plurality of zones, each zone of the plurality of zones having the one or more corresponding application thresholds associated with a target soil characteristic profile for each zone; an operation interface configured to control one or more of the prime mover or the slurry applicator according to the comparison of the determined one or more slurry characteristics with the one or more corresponding application thresholds.

In Example 2, the subject matter of Example 1 optionally includes wherein the operation interface controls one or more of the prime mover or the slurry applicator to apply a specified quantity of the agricultural slurry within each zone based on the comparison of the determined one or more slurry characteristics with the prescription map.

In Example 3, the subject matter of any one or more of Examples 1-2 optionally include wherein: the plurality of zones comprises a first zone and a second zone; the first zone has a first set of application thresholds; the second zone has a second set of application thresholds; and the operation interface is configured to control one or more of the prime mover or the slurry applicator according to a comparison of the determined one or more slurry characteristics with the first set of application thresholds and the second set of application thresholds.

In Example 4, the subject matter of Example 3 optionally includes wherein: the operation interface is configured to control one or more of the prime mover or the slurry applicator in a first operating condition based on the comparison of the determined one or more slurry characteristics with the first set of application thresholds; and the operation interface is configured to control one or more of the prime mover or the slurry applicator in a second operating condition based on the comparison of the determined one or more slurry characteristics the second set of application thresholds.

In Example 5, the subject matter of Example 4 optionally includes wherein: the operation interface is configured to control speed of the prime mover; the first operating condition comprises a first speed of the prime mover; the second operating condition comprises a second speed of the prime mover; and the first speed of the prime mover is different than the second speed of the prime mover.

In Example 6, the subject matter of Example 5 optionally includes wherein: the operation interface is configured to control a flow rate of agricultural slurry through the slurry applicator; the first operating condition comprises a first flow rate of agricultural slurry through the slurry applicator; the second operating condition comprises a second flow rate of agricultural slurry through the slurry applicator; and the first flow rate of agricultural slurry through the slurry applicator is different than the second flow rate.

In Example 7, the subject matter of Example 6 optionally includes wherein: the operation interface is configured to control a flow rate of agricultural slurry through the slurry applicator; the first operating condition comprises a first flow rate of agricultural slurry through the slurry applicator; the second operating condition comprises a second flow rate of agricultural slurry through the slurry applicator; and the first flow rate of agricultural slurry through the slurry applicator is different than the second flow rate.

In Example 8, the subject matter of any one or more of Examples 1-7 optionally include wherein the target soil characteristic profile comprises one or more of ammonia concentration in soil, ammonium concentration in the soil, nitrogen concentration in the soil, phosphorous concentration in the soil, or potassium concentration in the soil.

In Example 9, the subject matter of Example 8 optionally includes wherein the target soil characteristic profile is based on one or more of: type of crop grown in the soil grain yield goal for the type of crop grown in the soil, biomass yield goal for the type of crop grown in the soil, expected nutrient uptake for the type of crop grown in the soil, or an initial condition of the soil.

Example 10 is an agricultural slurry application system, comprising: a slurry reservoir configured to contain a quantity of the agricultural slurry; a slurry applicator configured to apply the agricultural slurry to soil, the agricultural slurry received from the slurry tank, and the slurry applicator is configured for coupling with a prime mover; a conduit in communication between the slurry reservoir and the slurry applicator; a slurry characteristic sensor coupled with one or more of the slurry reservoir or the conduit, wherein the slurry characteristic sensor is configured to determine one or more slurry characteristics; and a slurry application controller configured to control application of the agricultural slurry with one or more of the prime mover or the slurry applicator, the slurry application controller includes: an application control module configured to determine a slurry application value based on the determined one or more slurry characteristics and one or more corresponding application thresholds associated with a target characteristic profile; and an operation interface configured to control one or more of the prime mover or the slurry applicator according to the slurry application value.

In Example 11, the subject matter of Example 10 optionally includes wherein the slurry characteristic sensor is coupled along the fluid conduit.

In Example 12, the subject matter of any one or more of Examples 10-11 optionally include wherein the application control module is configured to determine the slurry application value based on a product of the slurry characteristics and the corresponding application thresholds.

In Example 13, the subject matter of Example 12 optionally includes wherein the operation interface controls a speed of the prime mover based on the slurry application value.

In Example 14, the subject matter of Example 13 optionally includes wherein: the operation interface is configured to increase the speed of the prime mover in correspondence with an increase in the slurry application value; and the operation interface is configured to decrease the speed of the prime mover in correspondence with a decrease in the slurry application value.

In Example 15, the subject matter of any one or more of Examples 13-14 optionally include wherein the operation interface is configured to maintain the speed of the prime mover in correspondence with a static slurry application value.

In Example 16, the subject matter of any one or more of Examples 13-15 optionally include wherein the operation interface is configured to control one or more of flow rate through the slurry applicator or dilution of the agricultural slurry based on the slurry application value.

In Example 17, the subject matter of any one or more of Examples 10-16 optionally include wherein: the one or more application thresholds comprise an active application threshold of a plurality of application thresholds, and each of the plurality of application thresholds is associated with respective zones of a prescription map; and the slurry application controller is configured to change the active application threshold based on a location of the prime mover with respect to the zones of the prescription map.

In Example 18, the subject matter of Example 17 optionally includes wherein the prescription map has a plurality of target soil characteristic profiles indexed to respective application thresholds.

In Example 19, the subject matter of any one or more of Examples 17-18 optionally include wherein the plurality of application thresholds comprise two or more target soil characteristic profiles including the active application threshold and at least one inactive application threshold, and the application control module is configured to determine the slurry application value based on the determined one or more slurry characteristics and the active application threshold.

In Example 20, the subject matter of any one or more of Examples 17-19 optionally include wherein the plurality of application thresholds are dynamic and correspondingly vary according to an initial soil characteristic profile, and the plurality of application thresholds are modified based on measured characteristics of soil to achieve adjusted application thresholds.

In Example 21, the subject matter of Example 20 optionally includes a soil characteristic sensor configured for coupling with the prime mover, and the soil characteristic sensor is configured to measure the characteristics of the soil.

In Example 22, the subject matter of any one or more of Examples 20-21 optionally include an in-ground soil characteristic sensor configured for communication with the soil, and the in-ground soil sensor is configured to measure the characteristics of the soil.

Example 23 is an agricultural slurry application system, comprising: a slurry reservoir configured to contain a reserve quantity of the agricultural slurry; a prime mover; a slurry applicator configured to apply the agricultural slurry from the slurry reservoir; a conduit in communication between the slurry tank and the slurry applicator; a slurry characteristic sensor coupled with one or more of the slurry tank or the conduit, wherein the slurry characteristic sensor is configured to determine one or more slurry characteristics; a soil characteristic sensor configured to determine one or more characteristics of soil; and a slurry application controller configured to control application of the agricultural slurry with one or more of the prime mover or the slurry applicator, the slurry application controller includes: a soil assessment module configured to adjust one or more application thresholds based on the determined one or more characteristics of the soil; and an operation interface configured to control one or more of the prime mover or the slurry applicator using a slurry application value based on the slurry characteristics and the adjusted one or more application thresholds.

In Example 24, the subject matter of Example 23 optionally includes wherein the operation interface controls one or more of the prime mover or the slurry applicator to apply a specified quantity of the agricultural slurry according to the slurry application value.

In Example 25, the subject matter of any one or more of Examples 23-24 optionally include wherein the slurry application value corresponds to a product of the adjusted one or more application thresholds and the slurry characteristics.

In Example 26, the subject matter of any one or more of Examples 23-25 optionally include wherein: the adjusted one or more application thresholds correspond to a difference between an initial application threshold and the soil characteristics.

In Example 27, the subject matter of any one or more of Examples 23-26 optionally include wherein the slurry characteristics comprise one or more of nitrogen concentration, ammonia concentration, ammonium concentration, phosphorous concentration, potassium concentration, or dry matter concentration of the agricultural slurry.

In Example 28, the subject matter of any one or more of Examples 23-27 optionally include wherein the operation interface is configured to use the slurry application value to apply the agricultural slurry and minimize a difference between a target soil characteristic profile and the determined one or more soil characteristics.

In Example 29, the subject matter of any one or more of Examples 23-28 optionally include wherein the slurry application controller is configured to determine the slurry application value using at least the slurry characteristics and a prescription map having a plurality of application thresholds associated with respective zones of a field where the agricultural slurry is applied.

In Example 30, the subject matter of Example 29 optionally includes wherein the plurality of application thresholds for the prescription map comprise a first application threshold associated with a first zone of the field and a second application threshold associated with a second zone of the field.

In Example 31, the subject matter of Example 30 optionally includes wherein the slurry application controller is configured to determine a first slurry application value using the first application threshold and the slurry characteristics.

In Example 32, the subject matter of Example 31 optionally includes wherein the slurry assessment module is configured to determine a second slurry application value using the second application threshold and the slurry characteristics.

In Example 33, the subject matter of Example 32 optionally includes wherein the operation interface is configured to control one or more of the prime mover or the slurry applicator to apply the agricultural slurry according to the first slurry application value and the second slurry application value.

In Example 34, the subject matter of Example 33 optionally includes wherein the operation interface is configured to control the prime mover to move at a first speed associated with the first slurry application value.

In Example 35, the subject matter of Example 34 optionally includes wherein the operation interface is configured to control the prime mover to move at a second speed associated with the second slurry application value.

In Example 36, the subject matter of any one or more of Examples 33-35 optionally include wherein the operation interface is configured to control the slurry applicator to permit a first flow rate of the agricultural slurry through the slurry applicator in correspondence with the first slurry application value.

In Example 37, the subject matter of Example 36 optionally includes wherein the operation interface is configured to control the slurry applicator to permit a second flow rate of the agricultural slurry through the slurry applicator in correspondence with the second slurry application value.

In Example 38, the subject matter of any one or more of Examples 23-37 optionally include wherein the agricultural slurry comprises manure.

Example 39 is a method for applying an agricultural slurry, the method comprising: determining characteristics of an agricultural slurry with a sensor in communication with a reservoir for the agricultural slurry or in communication with a conduit between the reservoir and a slurry applicator; comparing the slurry characteristics with one or more corresponding dynamic application thresholds associated with a target soil characteristic profile; and controlling one or more of a prime mover or the slurry applicator to apply the agricultural slurry according to the comparison.

In Example 40, the subject matter of Example 39 optionally includes determining characteristics of soil; comparing the characteristics of the soil with a target soil characteristic profile; and controlling one or more of a prime mover or a slurry applicator according to the comparison of the characteristics of the soil with the target soil characteristic profile.

In Example 41, the subject matter of any one or more of Examples 39-40 optionally include determining a slurry application value based on the comparison of the slurry characteristics with the corresponding dynamic application thresholds.

In Example 42, the subject matter of Example 41 optionally includes wherein the dynamic application thresholds are included in the prescription map, and controlling one or more of the prime mover or the slurry applicator includes applying a specified quantity of the agricultural slurry within each zone of a field based on a comparison of the determined one or more slurry characteristics with the prescription map.

In Example 43, the subject matter of any one or more of Examples 41-42 optionally include minimizing differences between a target soil characteristic profile and determined soil characteristics, minimizing the differences including applying the agricultural slurry to soil having the determined soil characteristics.

Each of these non-limiting examples can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An agricultural slurry application system, comprising:
a slurry reservoir configured to contain a quantity of the agricultural slurry;
a slurry applicator configured to apply the agricultural slurry to soil, the agricultural slurry received from the slurry tank, and the slurry applicator is configured for coupling with a prime mover;
a conduit in communication between the slurry reservoir and the slurry applicator;
a slurry characteristic sensor coupled with one or more of the slurry reservoir or the conduit, wherein the slurry characteristic sensor is configured to determine one or more slurry characteristics; and
a slurry application controller configured to control application of the agricultural slurry with one or more of the prime mover or the slurry applicator, the slurry application controller includes:
a characteristic comparator configured to compare the determined one or more slurry characteristics with one or more corresponding application thresholds of a prescription map, the prescription map having a plurality of zones, each zone of the plurality of zones having the one or more corresponding application thresholds associated with a target soil characteristic profile for each zone;
an operation interface configured to control one or more of the prime mover or the slurry applicator according to the comparison of the determined one or more slurry characteristics with the one or more corresponding application thresholds.

2. The agricultural slurry application system of claim 1, wherein the operation interface controls one or more of the prime mover or the slurry applicator to apply a specified quantity of the agricultural slurry within each zone based on the comparison of the determined one or more slurry characteristics with the prescription map.

3. The agricultural slurry application system of claim 1, wherein:
the plurality of zones comprises a first zone and a second zone;
the first zone has a first set of application thresholds;
the second zone has a second set of application thresholds; and
the operation interface is configured to control one or more of the prime mover or the slurry applicator according to a comparison of the determined one or more slurry characteristics with the first set of application thresholds and the second set of application thresholds.

4. The agricultural slurry application system of claim 3, wherein:
the operation interface is configured to control one or more of the prime mover or the slurry applicator in a first operating condition based on the comparison of the determined one or more slurry characteristics with the first set of application thresholds; and
the operation interface is configured to control one or more of the prime mover or the slurry applicator in a second operating condition based on the comparison of the determined one or more slurry characteristics the second set of application thresholds.

5. The agricultural slurry application system of claim 4, wherein:
the operation interface is configured to control speed of the prime mover;
the first operating condition comprises a first speed of the prime mover;
the second operating condition comprises a second speed of the prime mover; and
the first speed of the prime mover is different than the second speed of the prime mover.

6. The agricultural slurry application system of claim 5, wherein:
the operation interface is configured to control a flow rate of agricultural slurry through the slurry applicator;
the first operating condition comprises a first flow rate of agricultural slurry through the slurry applicator;
the second operating condition comprises a second flow rate of agricultural slurry through the slurry applicator; and
the first flow rate of agricultural slurry through the slurry applicator is different than the second flow rate.

7. The agricultural slurry application system of claim 6, wherein:
the operation interface is configured to control a flow rate of agricultural slurry through the slurry applicator;
the first operating condition comprises a first flow rate of agricultural slurry through the slurry applicator;
the second operating condition comprises a second flow rate of agricultural slurry through the slurry applicator; and
the first flow rate of agricultural slurry through the slurry applicator is different than the second flow rate.

8. The agricultural slurry application system of claim 1, wherein the target soil characteristic profile comprises one or more of ammonia concentration in soil, ammonium concentration in the soil, nitrogen concentration in the soil, phosphorous concentration in the soil, or potassium concentration in the soil.

9. The agricultural slurry application system of claim 8, wherein the target soil characteristic profile is based on one or more of: type of crop grown in the soil grain yield goal for the type of crop grown in the soil, biomass yield goal for the type of crop grown in the soil, expected nutrient uptake for the type of crop grown in the soil, or an initial condition of the soil.

10. An agricultural slurry application system, comprising:
a slurry reservoir configured to contain a quantity of the agricultural slurry;
a slurry applicator configured to apply the agricultural slurry to soil, the agricultural slurry received from the slurry tank, and the slurry applicator is configured for coupling with a prime mover;
a conduit in communication between the slurry reservoir and the slurry applicator;
a slurry characteristic sensor coupled with one or more of the slurry reservoir or the conduit, wherein the slurry characteristic sensor is configured to determine one or more slurry characteristics; and
a slurry application controller configured to control application of the agricultural slurry with one or more of the prime mover or the slurry applicator, the slurry application controller includes:
an application control module configured to determine a slurry application value based on the determined one or more slurry characteristics and one or more corresponding application thresholds associated with a target characteristic profile; and
an operation interface configured to control one or more of the prime mover or the slurry applicator according to the slurry application value.

11. The agricultural slurry application system of claim 10, wherein the slurry characteristic sensor is coupled along the fluid conduit.

12. The agricultural slurry application system of claim 10, wherein the application control module is configured to determine the slurry application value based on a product of the slurry characteristics and the corresponding application thresholds.

13. The agricultural slurry application system of claim 12, wherein the operation interface controls a speed of the prime mover based on the slurry application value.

14. The agricultural slurry application system of claim 13, wherein:
the operation interface is configured to increase the speed of the prime mover in correspondence with an increase in the slurry application value; and
the operation interface is configured to decrease the speed of the prime mover in correspondence with a decrease in the slurry application value.

15. The agricultural slurry application system of claim 13, wherein the operation interface is configured to maintain the speed of the prime mover in correspondence with a static slurry application value.

16. The agricultural slurry application system of claim 13, wherein the operation interface is configured to control one or more of flow rate through the slurry applicator or dilution of the agricultural slurry based on the slurry application value.

17. The agricultural slurry application system of claim 10, wherein:
the one or more application thresholds comprise an active application threshold of a plurality of application thresholds, and each of the plurality of application thresholds is associated with respective zones of a prescription map; and
the slurry application controller is configured to change the active application threshold based on a location of the prime mover with respect to the zones of the prescription map.

18. The agricultural slurry application system of claim 17, wherein the prescription map has a plurality of target soil characteristic profiles indexed to respective application thresholds.

19. The agricultural slurry application system of claim 17, wherein the plurality of application thresholds comprise two or more target soil characteristic profiles including the active application threshold and at least one inactive application threshold, and the application control module is configured to determine the slurry application value based on the determined one or more slurry characteristics and the active application threshold.

20. The agricultural slurry application system of claim 17, wherein the plurality of application thresholds are dynamic and correspondingly vary according to an initial soil characteristic profile, and the plurality of application thresholds are modified based on measured characteristics of soil to achieve adjusted application thresholds.

21. The agricultural slurry application system of claim 20, further comprising a soil characteristic sensor configured for coupling with the prime mover, and the soil characteristic sensor is configured to measure the characteristics of the soil.

22. The agricultural slurry application system of claim 20, further comprising an in-ground soil characteristic sensor configured for communication with the soil, and the in-ground soil sensor is configured to measure the characteristics of the soil.

23-38. (canceled)

39. A method for applying an agricultural slurry, the method comprising:
determining characteristics of an agricultural slurry with a sensor in communication with a reservoir for the agricultural slurry or in communication with a conduit between the reservoir and a slurry applicator;
comparing the slurry characteristics with one or more corresponding dynamic application thresholds associated with a target soil characteristic profile; and
controlling one or more of a prime mover or the slurry applicator to apply the agricultural slurry according to the comparison.

40. The method of claim 39, further comprising:
determining characteristics of soil;
comparing the characteristics of the soil with a target soil characteristic profile; and
controlling one or more of a prime mover or a slurry applicator according to the comparison of the characteristics of the soil with the target soil characteristic profile.

41. The method of claim 39, further comprising determining a slurry application value based on the comparison of the slurry characteristics with the corresponding dynamic application thresholds.

42. The method of claim 41, wherein the dynamic application thresholds are included in the prescription map, and controlling one or more of the prime mover or the slurry applicator includes applying a specified quantity of the agricultural slurry within each zone of a field based on a comparison of the determined one or more slurry characteristics with the prescription map.

43. The method of claim 41, further comprising minimizing differences between a target soil characteristic profile and determined soil characteristics, minimizing the differences including applying the agricultural slurry to soil having the determined soil characteristics.
